(19) United States
(12) Patent Application Publication
(10) Pub. No.: US 2026/0037964 A1
(43) Pub. Date: Feb. 5, 2026

(54) CONTROL METHOD, CONTROL DEVICE, AND RECORDING MEDIUM

(71) Applicant: Panasonic Intellectual Property Management Co., Ltd., Osaka (JP)

(72) Inventors: Takeru KOIE, Saitama (JP); Kakuya YAMAMOTO, Hyogo (JP); Ayaka NAKASAKA, Osaka (JP); Yuji UNAGAMI, Osaka (JP)

(21) Appl. No.: 19/351,883

(22) Filed: Oct. 7, 2025

Related U.S. Application Data
(63) Continuation of application No. PCT/JP2024/015706, filed on Apr. 22, 2024.
(60) Provisional application No. 63/461,674, filed on Apr. 25, 2023.

(51) Int. Cl. G06Q 20/38; G06Q 20/12

(52) U.S. Cl. CPC G06Q 20/3825; G06Q 20/123; G06Q 20/3827; G06Q 20/389

(57) ABSTRACT

A control method is a control method to be performed by a control device and includes: obtaining content information related to digital content created by a user; recording, into a first distributed ledger system, a first non-fungible token (NFT) corresponding to the content information; generating a second NFT for distribution that corresponds to the content information; and recording the generated second NFT into a second distributed ledger system different from the first distributed ledger system.

### CROSS REFERENCE TO RELATED APPLICATIONS

This is a continuation application of PCT International Application No. PCT/JP2024/015706 filed on Apr. 22, 2024, designating the United States of America, which is based on and claims priority of U.S. Provisional Patent Application No. 63/461,674 filed on Apr. 25, 2023. The entire disclosures of the above-identified applications, including the specifications, drawings and claims are incorporated herein by reference in their entirety.

### FIELD

The present disclosure relates to control methods, control devices, and recording media.

### BACKGROUND

Patent Literature (PTL) 1 discloses a technique to trade a non-fungible token (NFT) that is used to guarantee the uniqueness of digital content or prove the ownership of digital content.

### CITATION LIST

### Patent Literature

PTL 1: Japanese Patent No. 7129579

### SUMMARY

### Technical Problem

The present disclosure provides a control method, etc., in which digital content can be collected from users and digital content suitable for distribution can be effectively managed.

### Solution to Problem

A control method according to one aspect of the present disclosure is to be performed by a control device and includes: obtaining content information related to digital content created by a user; recording, into a first distributed ledger system, a first non-fungible token (NFT) corresponding to the content information; generating a second NFT corresponding to the content information, the second NFT being for distribution; and recording the second NFT generated, into a second distributed ledger system different from the first distributed ledger system.

A control device according to one aspect of the present disclosure includes: a processor; and memory, and using the memory, the processor: obtains content information related to digital content created by a user; records, into a first distributed ledger system, a first non-fungible token (NFT) corresponding to the content information; generates a second NFT corresponding to the content information, the second NFT being for distribution; and records the second NFT generated, into a second distributed ledger system different from the first distributed ledger system.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, and recording media.

### Advantageous Effects

In a control method, etc., according to the present disclosure, digital content can be collected from users and digital content suitable for distribution can be effectively managed.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a diagram for describing the outline of a system according to an embodiment.

FIG. 2 is a block diagram illustrating an example of the configuration of a user terminal according to an embodiment.

FIG. 3 is a block diagram illustrating an example of the configuration of an administrator terminal according to an embodiment.

FIG. 4 is a block diagram illustrating an example of the configuration of a distributor terminal according to an embodiment.

FIG. 5 is a sequence chart illustrating an example of a process by which a first NFT is registered in an embodiment.

FIG. 6 is a sequence chart illustrating an example of a process by which a second NFT is registered in an embodiment.

FIG. 7 is a sequence chart illustrating an example of a process by which remuneration for the use of digital content is paid in an embodiment.

FIG. 8 is a diagram for describing the flow of information in each process of the operation of a system.

FIG. 9 is a diagram for describing the flow of information in each process of the operation of a system.

FIG. 10 is a diagram for describing the flow of information in each process of the operation of a system.

FIG. 11 is a diagram for describing the flow of information in each process of the operation of a system.

FIG. 12 is a diagram for describing the flow of information in each process of the operation of a system.

FIG. 13 is a diagram for describing a first example of payment between an administrator and a distributor.

FIG. 14 is a diagram for describing a second example of payment between an administrator and a distributor.

FIG. 15 is a diagram for describing a third example of payment between an administrator and a distributor.

FIG. 16 is an explanatory diagram illustrating the data structure of a blockchain.

FIG. 17 is an explanatory diagram illustrating the data structure of transaction data.

FIG. 18 is an explanatory diagram illustrating transaction data related to execution of a smart contract.

FIG. 19 is an explanatory diagram illustrating processing related to execution of a smart contract.

### DESCRIPTION OF EMBODIMENT

### Underlying Knowledge Forming Basis of the Present Disclosure

In recent years, a variety of digital content is managed in association with NFTs. By using NFTs, it is possible to ensure the uniqueness of digital content and easily specify the owner of digital content.

It is conceivable that a distributor who distributes digital content uses and distributes digital content managed by a distributed ledger system for content for distribution in which the distributor participates. In the distributed ledger system for content for distribution, digital content suitable for distribution is managed, and digital content not suitable for distribution is not managed. By selecting, as content for distribution, the digital content managed on the distributed ledger for content for distribution, a distributor can reduce the risk of inadvertently distributing digital content not suitable for distribution. Therefore, in the distributed ledger system for content for distribution, it is necessary to prevent digital content not suitable for distribution from being registered and eliminate such digital content. The digital content suitable for distribution is videos that prioritize immediacy, for example, and the digital content not suitable for distribution is fake videos, for example.

Note that it is likely that the digital content suitable for distribution such as videos that prioritize immediacy is videos captured by general users. Since videos that prioritize immediacy often show spontaneous events occurring in unexpected locations, the videos tend to have been captured by smartphones held by general users. Thus, if digital content suitable for distribution can be collected from general users, the amount of digital content suitable for distribution can be efficiently increased.

However, if general users can register digital content freely and directly with a distributed ledger system for content for distribution, there is a risk that digital content not suitable for distribution may also be registered. On the other hand, if general users cannot freely register digital content with the distributed ledger system, it is difficult to collect digital content from general users.

The inventors have conceived of a control method, etc., in which digital content can be collected from users and digital content suitable for distribution can be effectively managed.

A control method according to the first aspect of the present disclosure is to be performed by a control device and includes: obtaining content information related to digital content created by a user; recording, into a first distributed ledger system, a first non-fungible token (NFT) corresponding to the content information; generating a second NFT corresponding to the content information, the second NFT being for distribution; and recording the second NFT generated, into a second distributed ledger system different from the first distributed ledger system.

Thus, the digital content created by a user and the digital content for distribution are separately managed in two different distributed ledger systems; therefore, digital content can be collected from users and digital content suitable for distribution can be effectively managed. Furthermore, since a single control device performs the processes in the two distributed ledger systems, it is possible to reduce the communications traffic, the data processing load, and the data storage capacity.

A control method according to the second aspect of the present disclosure is the control method according to the first aspect in which the first NFT includes information for specifying: a user identification (ID) for identifying the user; and a content ID for identifying the digital content, and the second NFT includes information for specifying the content ID.

A control method according to the third aspect of the present disclosure is the control method according to the second aspect in which the first distributed ledger system includes: a user terminal owned by the user; and the control device, and the second distributed ledger system includes: a distributor terminal owned by a distributor who distributes digital content; and the control device.

A control method according to the fourth aspect of the present disclosure is the control method according to the second aspect or the third aspect in which in the obtaining, first transaction data including the content information is obtained to obtain the content information. The control method further includes recording the first transaction data into the first distributed ledger system. The first NFT is recorded by execution of a first contract code stored in the first distributed ledger system that is triggered by the recording of the first transaction data into the first distributed ledger system.

A control method according to the fifth aspect of the present disclosure is the control method according to any one of the second aspect to the fourth aspect that further includes: when the first NFT is recorded into the first distributed ledger system, generating second transaction data including first NFT information related to the first NFT; and recording the second transaction data into the second distributed ledger system. The second NFT is generated and recorded by execution of a second contract code stored in the second distributed ledger system that is triggered by the recording of the second transaction data into the second distributed ledger system.

A control method according to the sixth aspect of the present disclosure is the control method according to any one of the second aspect to the fifth aspect that further incudes: obtaining third transaction data including the content ID and a first token for paying, to an administrator, remuneration for use of the digital content in distribution by a distributor; recording the third transaction data into the second distributed ledger system; and transferring the first token from an account of the distributor to an account of the administrator.

A control method according to the seventh aspect of the present disclosure is the control method according to the sixth aspect in which the first token is transferred by execution of a third contract code stored in the second distributed ledger system that is triggered by the recording of the third transaction data into the second distributed ledger system.

A control method according to the eighth aspect of the present disclosure is the control method according to the sixth aspect or the seventh aspect that further includes: after the transferring of the first token, generating fourth transaction data including a second token and second NFT information corresponding to the content ID, the second token being for paying, to the user, remuneration for the use of the digital content in distribution and being at least part of the first token; recording the fourth transaction data into the first distributed ledger system; and transferring the second token from the account of the administrator to an account of an owner of the first NFT.

Therefore, the remuneration for the distribution of digital content can be properly distributed to the owner of the first NFT corresponding to the digital content.

A control method according to the ninth aspect of the present disclosure is the control method according to the eighth aspect in which the second token is transferred by execution of a fourth contract code stored in the first distributed ledger system that is triggered by the recording of the fourth transaction data into the first distributed ledger system, and in the transferring of the second token, the first NFT recorded in the first distributed ledger system is specified based on the second NFT information included in the fourth transaction data, and the second token is transferred to the account of the owner of the first NFT specified based on the first NFT.

A control device according to the tenth aspect of the present disclosure includes: a processor; and memory. Using the memory, the processor: obtains content information related to digital content created by a user; records, into a first distributed ledger system, a first non-fungible token (NFT) corresponding to the content information; generates a second NFT corresponding to the content information, the second NFT being for distribution; and records the second NFT generated, into a second distributed ledger system different from the first distributed ledger system.

Thus, the digital content created by a user and the digital content for distribution are separately managed in two different distributed ledger systems; therefore, digital content can be collected from users and digital content suitable for distribution can be effectively managed. Furthermore, since a single control device performs the processes in the two distributed ledger systems, it is possible to reduce the communications traffic, the data processing load, and the data storage capacity.

A recording medium according to the eleventh aspect of the present disclosure is a non-transitory computer-readable recording medium having stored thereon a program for causing a computer to execute the control method according to any one of the first aspect to the ninth aspect.

Thus, the digital content created by a user and the digital content for distribution are separately managed in two different distributed ledger systems; therefore, digital content can be collected from users and digital content suitable for distribution can be effectively managed. Furthermore, since a single control device performs the processes in the two distributed ledger systems, it is possible to reduce the communications traffic, the data processing load, and the data storage capacity.

Note that these general and specific aspects may be implemented using a system, a device, an integrated circuit, a computer program, or a computer-readable recording medium such as CD-ROM, or any combination of systems, devices, integrated circuits, computer programs, and recording media.

Hereinafter, an embodiment will be described with reference to the drawings. Note that each embodiment described below shows one specific example of the present disclosure. The numerical values, shapes, materials, structural elements, the arrangement and connection of the structural elements, steps, the processing order of the steps, etc., shown in the following embodiment are mere examples, and are not intended to limit the present disclosure.

Among the structural elements in the following embodiment, structural elements not recited in any one of the independent claims which indicate the broadest concepts are not necessarily required to achieve the object of the present disclosure, but are described as structural elements included in a more preferred embodiment.

### Embodiment

The present embodiment describes a control method, etc., in which digital content can be collected from users and digital content suitable for distribution can be effectively managed.

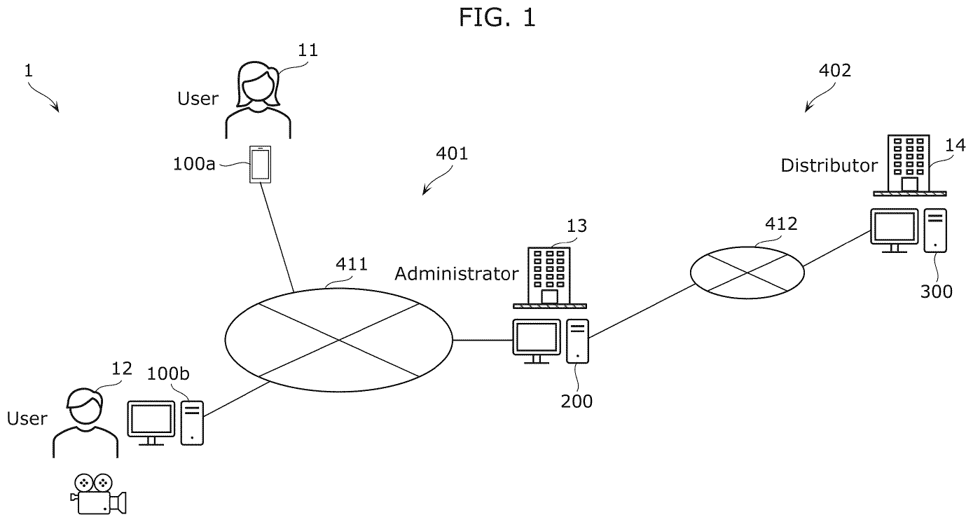

FIG. 1 is a diagram for describing the outline of a system according to the embodiment.

System 1 includes user terminals 100a, 100b, administrator terminal 200, and distributor terminal 300. System 1 includes two networks that realize two distributed ledger systems. The two networks include first chain network 401 and second chain network 402.

First chain network 401 is formed by connecting, via communication network 411, user terminal 100a, which is a terminal of user 11, user terminal 100b, which is a terminal of user 12, and administrator terminal 200, which is a terminal of administrator 13 that administers the two distributed ledger systems. First chain network 401 constitutes a first distributed ledger system for digital content collection that manages photographs (still images) or moving images captured by user 11 and user 12. Note that the photographs or the moving images are an example of digital content. The digital content is not limited to video content such as photographs and moving images and may also be audio content such as voice and sound.

Second chain network 402 is formed by connecting administrator terminal 200 and distributor terminal 300 of distributor 14 of digital content via communication network 412. Second chain network 402 constitutes a second distributed ledger system for distribution that manages digital content to be distributed by distributor 14. Examples of the digital content distribution include distributing digital content by broadcasting, distributing digital content on demand via a network, and distributing digital content in real time via a network.

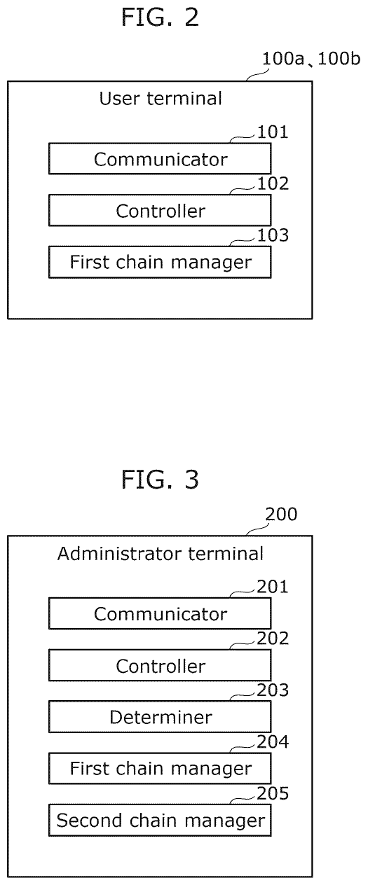

FIG. 2 is a block diagram illustrating an example of the configuration of the user terminal according to the embodiment.

As illustrated in FIG. 2, each of user terminals 100a, 100b includes communicator 101, controller 102, and first chain manager 103. Communicator 101, controller 102, and first chain manager 103 can be implemented by a processor (for example, a central processing unit (CPU)) (not illustrated in the drawings) included in the corresponding user terminal executing a predetermined program using memory (not illustrated in the drawings).

Communicator 101 communicates with at least one of another user terminal and administrator terminal 200 via communication network 411. Communicator 101 receives information from at least one of another user terminal and administrator terminal 200. Communicator 101 transmits information to at least one of another user terminal and administrator terminal 200.

Specifically, communicator 101 transmits, to administrator terminal 200, a registration request for registering a non-fungible token (NFT) in first chain network 401. Communicator 101 receives, from administrator terminal 200, a response to the registration request.

Controller 102 performs various processes on the basis of the received information. Specifically, controller 102 stores the received information into storage. Furthermore, controller 102 performs the process for minting an NFT of digital content. The process for minting an NFT is, for example, the process of causing communicator 101 to transmit the NFT registration request to administrator terminal 200.

First chain manager 103 manages first chain network 401. In first chain network 401, a first blockchain is managed on which a first NFT corresponding to the collected digital content is stored. Examples of the management herein include storing, updating, deleting, and changing data (information) to be managed.

FIG. 3 is a block diagram illustrating an example of the configuration of the administrator terminal according to the embodiment.

As illustrated in FIG. 3, administrator terminal 200 includes communicator 201, controller 202, determiner 203, first chain manager 204, and second chain manager 205. Communicator 201, controller 202, determiner 203, first chain manager 204, and second chain manager 205 can be implemented by a processor (for example, a central processing unit (CPU)) (not illustrated in the drawings) included in administrator terminal 200 executing a predetermined program using memory (not illustrated in the drawings). Administrator terminal 200 is an example of the control device.

Communicator 201 communicates with at least one of user terminals 100a, 100b via communication network 411. Furthermore, communicator 201 communicates with distributor terminal 300 via communication network 412. 201 Communicator receives information from at least one of user terminals 100a, 100b and distributor terminal 300. Communicator 201 transmits information to at least one of user terminals 100a, 100b and distributor terminal 300.

Specifically, communicator 201 receives, from user terminal 100a (or user terminal 100b), a registration request for registering an NFT in first chain network 401. Communicator 201 transmits, to user terminal 100a (or user terminal 100b), a response to the registration request. Furthermore, communicator 201 receives, from distributor terminal 300, first payment transaction data including: a first token for paying, to administrator 13, remuneration for the use of digital content in distribution; and a content identification (ID) for identifying the digital content. The first payment transaction data is an example of the third transaction data.

Controller 202 performs various processes on the basis of the received information. Specifically, controller 202 stores the received information into storage. Furthermore, in response to the registration request, controller 202 performs the process of issuing the first NFT corresponding to the digital content and registering the first NFT in first chain network 401. Moreover, according to the determination result of determiner 203, controller 202 performs the process of issuing a second NFT corresponding to the digital content corresponding to the first NFT and registering the second NFT in second chain network 402.

By monitoring first chain manager 204, determiner 203 determines whether the first NFT has been registered in first chain network 401 managed by first chain manager 204. When it is determined that the first NFT has been registered in first chain network 401, controller 202 performs the process of issuing the second NFT and registering the second NFT in second chain network 402.

Note that determiner 203 may further determine whether the digital content corresponding to the first NFT registered in first chain network 401 is suitable for distribution. In a situation where this determination is to be made, when it is determined that the first NFT has been registered in first chain network 401 and it is determined that the digital content corresponding to the first NFT is suitable for distribution, controller 202 performs the process of issuing the second NFT and registering the second NFT in second chain network 402. As a result, the second NFT registered in second chain network 402 corresponds to the digital content determined to have been suitable for distribution, meaning that only the digital content suitable for distribution is managed in second chain network 402.

First chain manager 204 manages first chain network 401.

Second chain manager 205 manages second chain network 402. In second chain network 402, a second blockchain is managed on which the second NFT corresponding to the digital content for distribution is stored. Examples of the management herein include storing, updating, deleting, and changing data (information) to be managed.

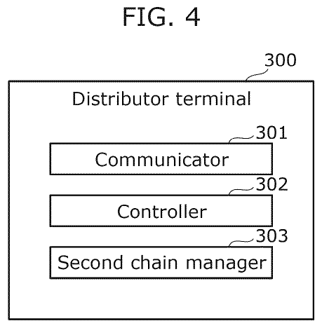

FIG. 4 is a block diagram illustrating an example of the configuration of the distributor terminal according to the embodiment.

As illustrated in FIG. 4, distributor terminal 300 includes communicator 301, controller 302, and second chain manager 303. Communicator 301, controller 302, and second chain manager 303 can be implemented by a processor (for example, a central processing unit (CPU)) (not illustrated in the drawings) included in distributor terminal 300 executing a predetermined program using memory (not illustrated in the drawings).

Communicator 301 communicates with administrator terminal 200 via communication network 412. Communicator 301 receives information from administrator terminal 200. Communicator 301 transmits information to administrator terminal 200. Specifically, communicator 301 transmits, to administrator terminal 200, first payment transaction data including: a first token for paying, to administrator 13, remuneration for the use of digital content in distribution; and a content ID for identifying the digital content. This remuneration may be set to a value that depends on the rarity of the digital content. For example, a higher price may be set as the rarity increases. The rarity may be determined so as to increase as the number of captured videos of the same scene decreases, for example.

Controller 302 performs various processes on the basis of the received information. Specifically, controller 302 stores the received information into storage. Furthermore, controller 302 performs the process of selecting digital content corresponding to the second NFT and distributing the digital content. In selecting digital content, input from distributor 14 may be accepted so that digital content is selected according to the accepted input. Furthermore, controller 302 performs the process for paying, to administrator 13, remuneration for the use of the digital content in distribution. This process for payment is the process of causing communicator 301 to transmit, to administrator terminal 200, the first payment transaction data including: a first token for paying, to administrator 13, remuneration for the use of digital content in distribution; and a content ID for identifying the digital content, for example.

Second chain manager 303 manages second chain network 402.

### [Operation of System]

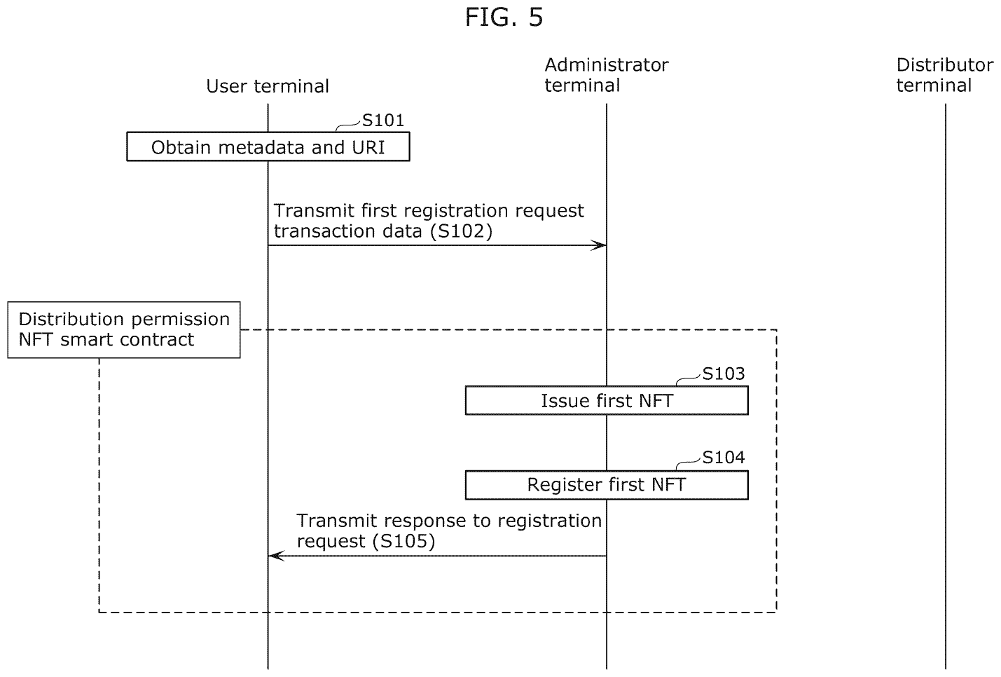

Next, the operation of system 1 configured as described above will be described with reference to FIG. 5 to FIG. 10.

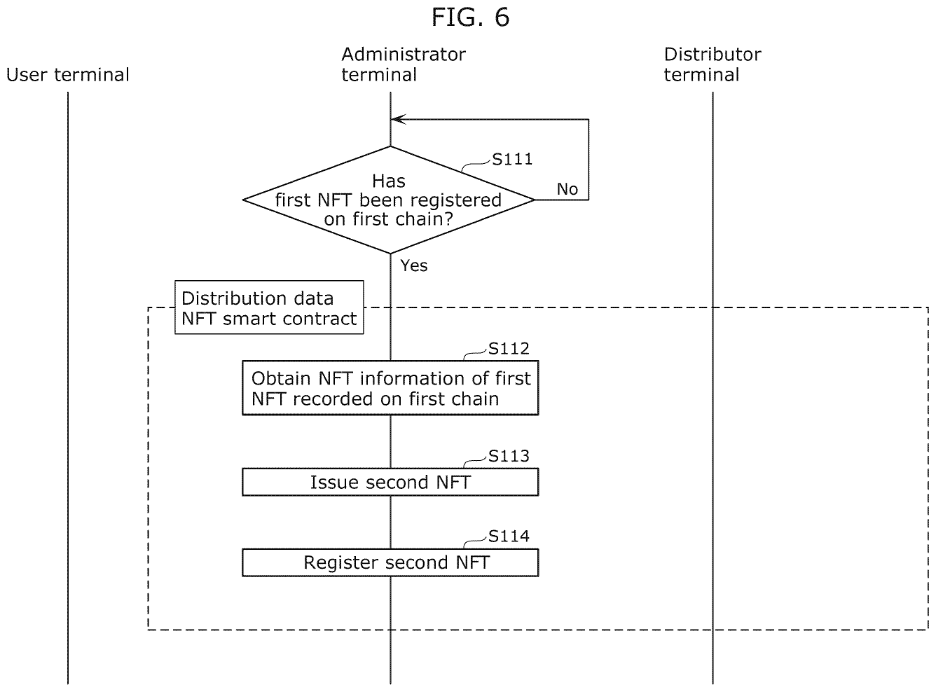

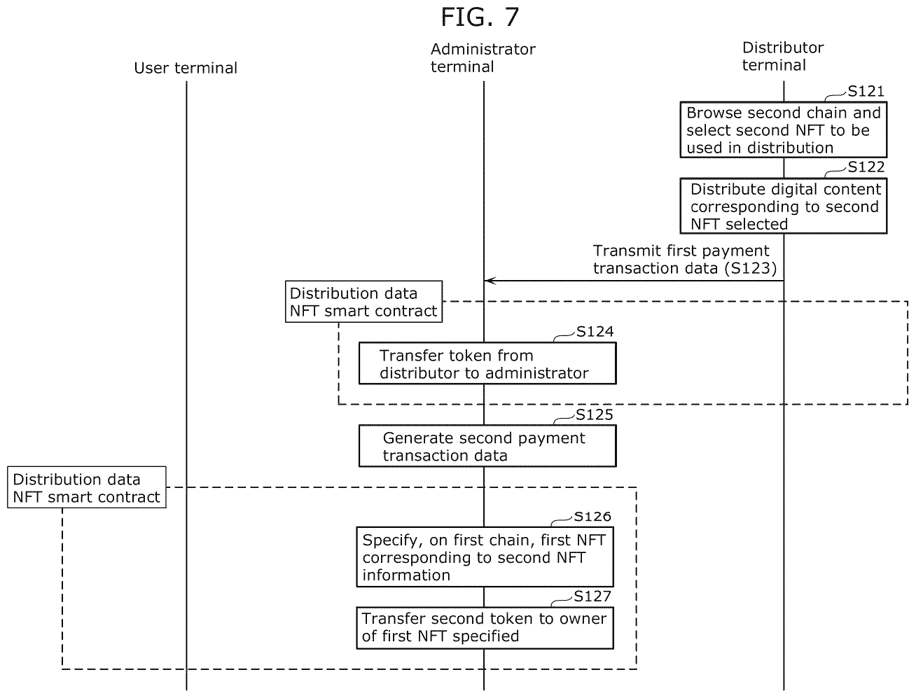

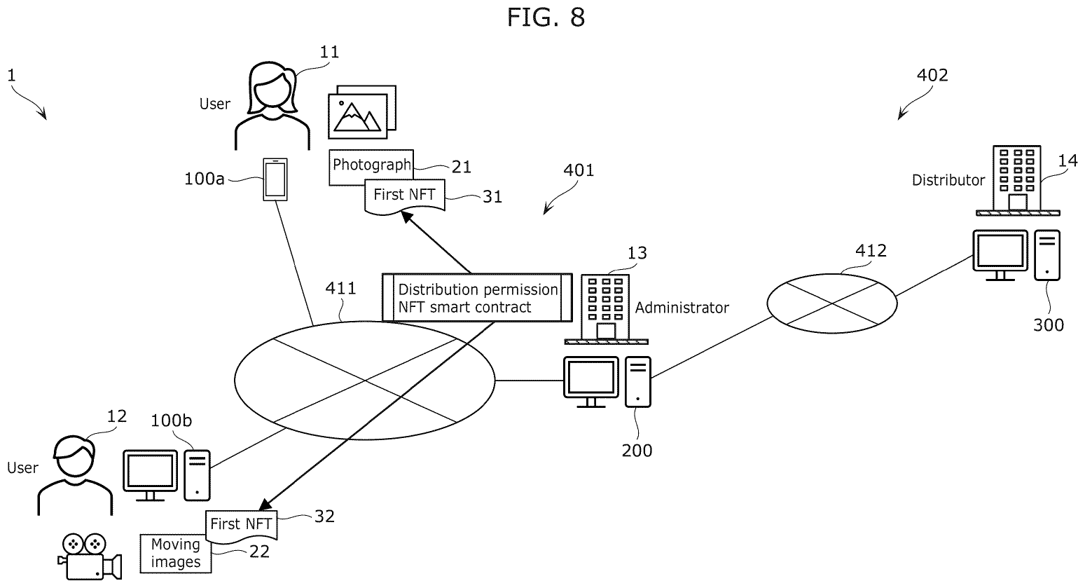

FIG. 5 is a sequence chart illustrating an example of a process by which the first NFT is registered in the embodiment. FIG. 6 is a sequence chart illustrating an example of a process by which the second NFT is registered in the embodiment. FIG. 7 is a sequence chart illustrating an example of a process by which remuneration for the use of digital content is paid in the embodiment. FIG. 8 to FIG. 12 are diagrams for describing the flow of information in processes of the operation of the system.

In these diagrams, the first chain represents first chain network 401, and the second chain represents second chain network 402. In the description of these sequence charts, an example where user terminal 100a is used will be described, but substantially the same processes are performed in the case where user terminal 100b is used.

User terminal 100a obtains metadata and a uniform resource identifier (URI) (S101). The metadata includes content information related to the digital content corresponding to the first NFT, for example. The metadata may include owner information for identifying the owner of the first NFT. The URI indicates an address at which the metadata is stored.

User terminal 100a transmits, to administrator terminal 200, first registration request transaction data including a registration request for registering the first NFT (S102). The registration request includes the metadata and the URI. The first registration request transaction data is an example of the first transaction data.

Administrator terminal 200 records the first registration request transaction data into first chain network 401, and as triggered by the first registration request transaction data being recorded into first chain network 401, executes a first contract code stored in first chain network 401. The first contract code is a code that implements a distribution permission NFT smart contract for performing Steps S103 to S105.

Administrator terminal 200 issues the first NFT by generating a new NFT ID in response to the registration request included in the first registration request transaction data (S103).

Administrator terminal 200 registers the first NFT in the first blockchain by recording the NFT ID issued in Step S103 into first chain network 401 managed by first chain manager 204 (S104).

Administrator terminal 200 transmits, to user terminal 100a, information indicating that the new NFT has been issued, as a response to the registration request (S105).

For example, as illustrated in FIG. 8, first NFT 31 corresponding to photograph 21 taken by user 11 is issued when the distribution permission NFT smart contract is executed, and first NFT 32 corresponding to moving images 22 captured by user 12 is issued when the distribution permission NFT smart contract is executed.

By monitoring first chain manager 204, administrator terminal 200 determines whether the first NFT has been registered in first chain network 401 managed by first chain manager 204 (S111).

When the first NFT is registered in first chain network 401 (Yes in S111), administrator terminal 200 performs Steps S112 to S114, and when the first NFT is not registered in first chain network 401 (No in S111), administrator terminal 200 repeats Step S111.

Administrator terminal 200 generates second registration request transaction data including first NFT information related to the first NFT, and records the second registration request transaction data into second chain network 402. The second registration request transaction data includes information for issuing the second NFT. The information for issuing the second NFT includes metadata and an URI. The metadata includes content information related to the digital content corresponding to the second NFT, for example. The metadata may include owner information for identifying the owner of the second NFT. The URI indicates an address at which the metadata is stored. As triggered by the second registration request transaction data being recorded into second chain network 402, administrator terminal 200 executes a second contract code stored in second chain network 402. The second contract code is a code that implements a distribution data NFT smart contract for performing Steps S112 to S114. The first NFT information includes the NFT ID of the first NFT and the user ID of a user who has created the digital content corresponding to the first NFT. The second registration request transaction data is an example of the second transaction data.

Administrator terminal 200 obtains the first NFT information of the first NFT newly recorded into first chain network 401 (S112). The first NFT newly recorded is the first NFT determined in Step S111 to have been registered in first chain network 401.

Administrator terminal 200 issues the second NFT by generating a new NFT ID in response to the registration request included in the second registration request transaction data (S113).

Administrator terminal 200 registers the second NFT in the second blockchain by recording the NFT ID issued in Step S113 into second chain network 402 managed by second chain manager 205 (S114).

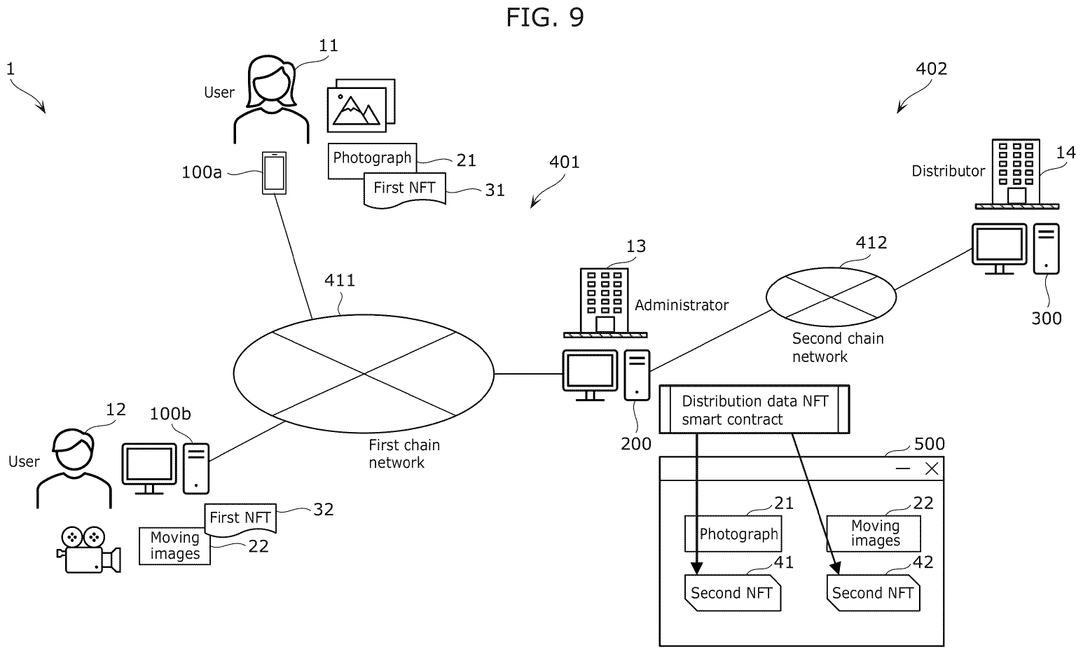

For example, as illustrated in FIG. 9, second NFT 41 corresponding to photograph 21 taken by user 11 is issued when the distribution data NFT smart contract is executed, and second NFT 42 corresponding to moving images 22 captured by user 12 is issued when the distribution data NFT smart contract is executed.

Using distributor terminal 300, distributor 14 browses a plurality of second NFTs stored in second chain network 402, and selects the second NFT to be used in distribution (S121). For example, distributor 14 browses user interface (UI) 500 illustrated in FIG. 9 and thus selects the second NFT to be used in distribution. Distributor terminal 300 accepts input for selecting the second NFT to be used in distribution.

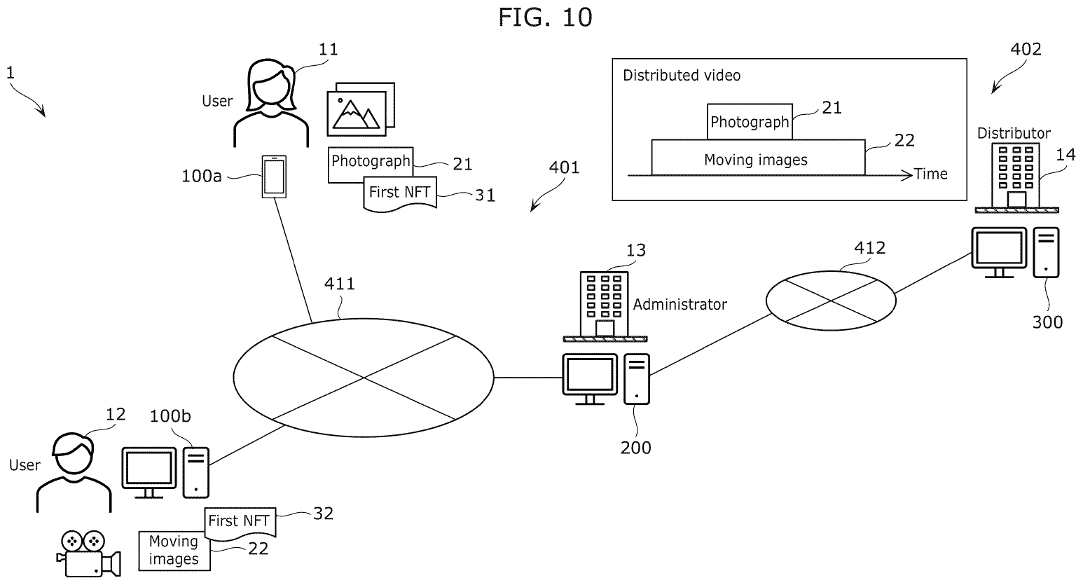

Distributor terminal 300 distributes the digital content corresponding to the second NFT selected (S122). For example, distributor terminal 300 distributes video including photograph 21 and moving images 22 as illustrated in FIG. 10. A distribution destination may be set to only a user terminal of a user who subscribes to a distribution service provided by distributor 14 or may be set to include a user terminal of a user who does not subscribe to a distribution service provided by distributor 14.

Distributor terminal 300 transmits, to administrator terminal 200, first payment transaction data including: a first token for paying, to administrator 13, remuneration for the use of digital content in distribution; and a content ID for identifying the digital content (S123).

Administrator terminal 200 records the first payment transaction data into second chain network 402, and as triggered by the first payment transaction data being recorded into second chain network 402, executes a third contract code stored in second chain network 402. The third contract code is a code that implements a distribution data NFT smart contract for performing Step S124.

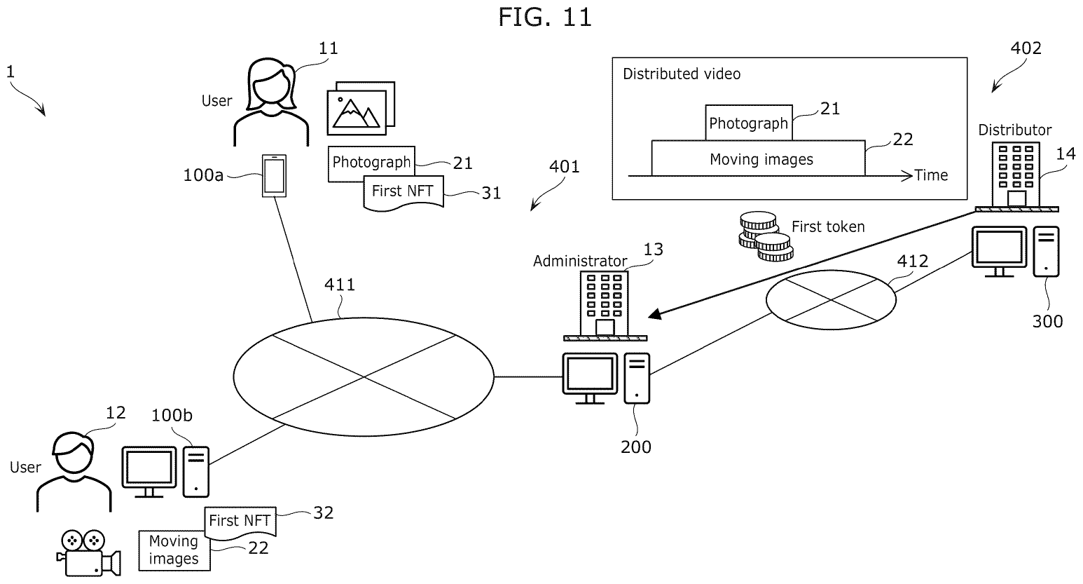

Administrator terminal 200 transfers the first token from the account of the distributor to the account of the administrator by executing the third contract code (S124). As a result, the payment of the first token from distributor 14 to administrator 13 is completed, as illustrated in FIG. 11, for example. Information for specifying the account of the distributor and the account of the administrator is registered in administrator terminal 200 in advance and may be stored in the storage in administrator terminal 200.

After the transfer in Step S124, administrator terminal 200 generates second payment transaction data including a second token and second NFT information (S125). The second token is a token that corresponds to remuneration for the use of digital content in distribution and is for payment of the remuneration to a user who has created the digital content. The second token is at least part of the first token. The second payment transaction data is an example of the fourth transaction data. The second NFT information includes an NFT ID for identifying the second NFT corresponding to the digital content identified by the content ID included in the first payment transaction data.

Administrator terminal 200 records the second payment transaction data into first chain network 401. Subsequently, as triggered by the second payment transaction data being recorded into first chain network 401, administrator terminal 200 executes a fourth contract code stored in first chain network 401. The fourth contract code is a code that implements a distribution data NFT smart contract for performing Steps S126 to S127.

On the basis of the second NFT information included in the second payment transaction data, administrator terminal 200 specifies, from among a plurality of first NFTs recorded in first chain network 401, the first NFT corresponding to the digital content identified by the content ID corresponding to the second NFT information (S126).

Administrator terminal 200 transfers the second token to the account of the owner of the first NFT specified based on the specified first NFT (S127).

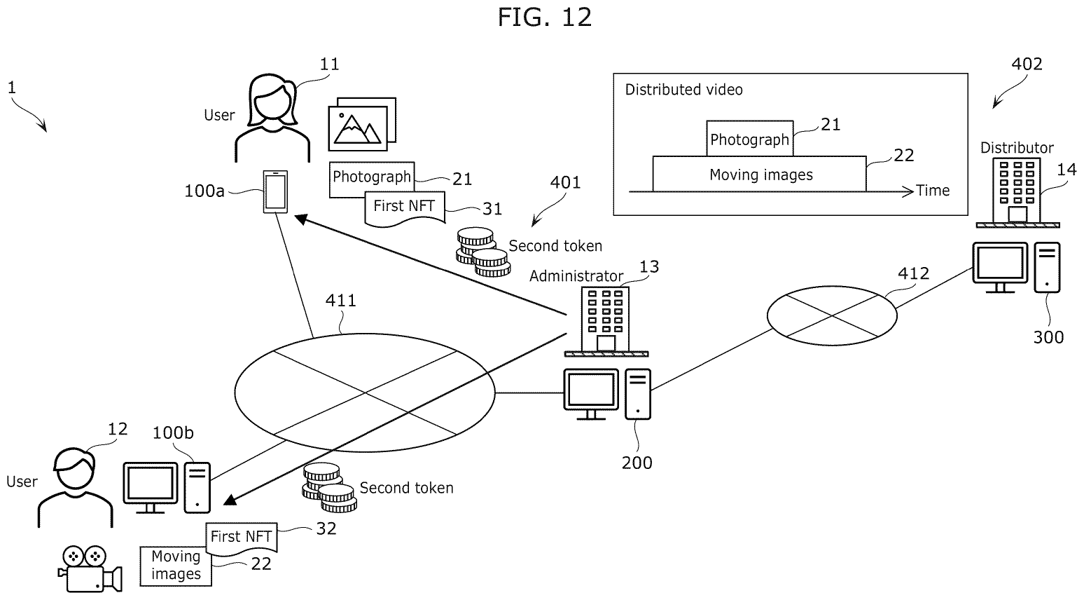

As a result, since the distributed video includes the plurality of items of digital content (specifically, photograph 21 and moving images 22), the second token based on the first token is distributed to users 11, 12 who have taken these photograph 21 and moving images 22, as illustrated in FIG. 12, for example.

### [Payment Between Administrator and Distributor]

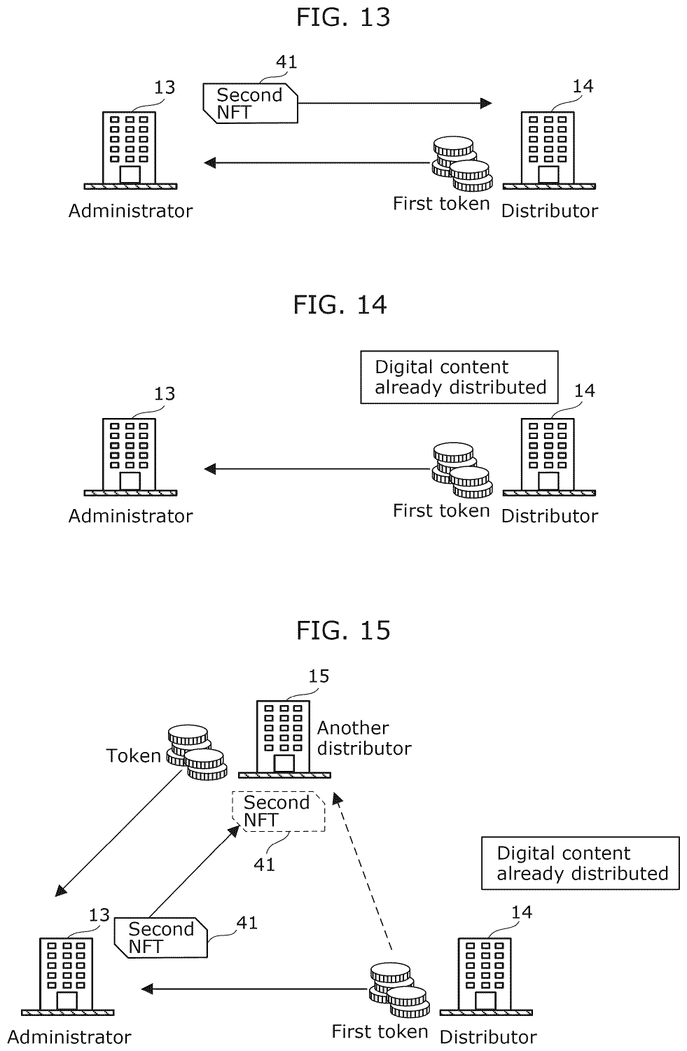

FIG. 13 to FIG. 15 are diagrams for describing payment between the administrator and the distributor.

As illustrated in FIG. 13, administrator 13 may receive the first token as remuneration for the transfer of the ownership of second NFT 41 to distributor 14. In this case, distributor 14 can acquire the ownership of second NFT 41 and therefore can freely distribute, without further payment, the digital content corresponding to second NFT 41 the ownership of which has been acquired.

As illustrated in FIG. 14, administrator 13 may receive the first token as remuneration for the distribution of the digital content.

As illustrated in FIG. 15, distributor 14 who has used second NFT 41 during a period in which administrator 13 owns second NFT 41 pays the first token to administrator 13 who owns second NFT 41. Furthermore, administrator 13 may sell the ownership of second NFT 41 to another distributor 15 in exchange for tokens as remuneration. When distributor 14 distributes the digital content corresponding to second NFT 41 after the ownership of second NFT 41 is transferred to another distributor 15, another distributor 15 may receive the first token from distributor 14 as remuneration for the distribution.

### Advantageous Effects, Etc.

In the control method according to the present embodiment, administrator terminal 200 (the control device) obtains content information related to digital content created by a user. Administrator terminal 200 records, into first chain network 401 (the first distributed ledger system), the first non-fungible token (NFT) corresponding to the content information. Administrator terminal 200 generates the second NFT for distribution that corresponds to the content information. Administrator terminal 200 records the generated second NFT into second chain network 402 different from first chain network 401.

Thus, the digital content created by a user and the digital content for distribution are separately managed in two chain networks (distributed ledger systems); therefore, digital content can be collected from users and digital content suitable for distribution can be effectively managed. Furthermore, since single administrator terminal 200 performs the processes in the two chain networks, it is possible to reduce the communications traffic, the data processing load, and the data storage capacity.

In the control method according to the present embodiment, administrator terminal 200 further obtains first payment transaction data including: a first token for paying, to an administrator, remuneration for the use of digital content in distribution by a distributor; and a content ID. Administrator terminal 200 records the first payment transaction data into second chain network 402. Administrator terminal 200 transfers the first token from the account of the distributor to the account of the administrator.

In the control method according to the present embodiment, the first token is transferred by execution of a third contract code stored in second chain network 402 that is triggered by the recording of the first payment transaction data into second chain network 402.

In the control method according to the present embodiment, administrator terminal 200 further generates, after the transfer, second payment transaction data including: a second token for paying, to the user, remuneration for the use of the digital content in distribution, the second token being at least part of the first token; and second NFT information corresponding to the content ID. Administrator terminal 200 records the second payment transaction data into first chain network 401. Administrator terminal 200 transfers the second token from the account of the administrator to the account of the owner of the first NFT.

Therefore, the remuneration for the distribution of digital content can be properly distributed to the owner of the first NFT corresponding to the digital content.

### [Variations]

(1) The above embodiment describes an example where system 1 includes one first chain network 401 including user terminals 100a, 100b and administrator terminal 200, but system 1 may include a plurality of first chain networks.
(2) In the above embodiment, the first NFT is issued by administrator terminal 200 and registered in first chain network 401, but the first NFT may be issued by user terminals 100a, 100b and registered in first chain network 401. Furthermore, the settings may be configured such that only administrator terminal 200 is permitted to issue and register the first NFT.
(3) In the above embodiment, when system 1 includes a plurality of first chain networks, whether the digital content corresponding to the first NFT is suitable for distribution may be determined according to the reliability of each of the plurality of first chain networks.
(4) In the above embodiment, the second NFT that is generated for registration as digital content for distribution is generated for digital content in one-to-one correspondence, but this is not limiting; two or more second NFTs may be generated for one item of digital content.
(5) In the above embodiment, the ownership of the first NFT may be transferred from a user who has created the digital content corresponding to the first NFT to another user.
(6) In determining whether the digital content corresponding to the first NFT is suitable for distribution in the above embodiment, the reliability of each of the digital content, a user who has created the digital content, the owner of the first NFT corresponding to the digital content, and the first chain network in which the first NFT corresponding to the digital content is managed may be calculated, and said determination may be made according to the reliability.
(7) In the above embodiment, whether the digital content corresponding to the first NFT is suitable for distribution may be determined by a person or may be determined using a machine learning model.

### Additional Comments

The following are additional comments on the distributed ledger according to the embodiment or the variations described above. A blockchain will be described herein as an example of the distributed ledger; the same is true for other distributed ledgers.

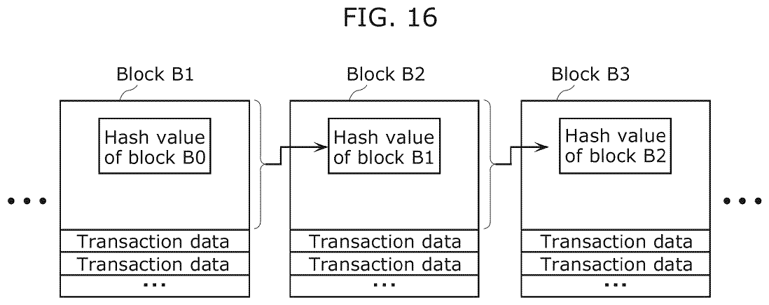

FIG. 16 is an explanatory diagram illustrating the data structure of a blockchain.

The blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks as hash values; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

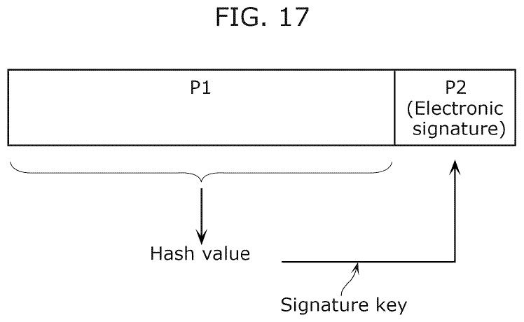

FIG. 17 is an explanatory diagram illustrating the data structure of transaction data.

The transaction data illustrated in FIG. 17 includes transaction body P1 and digital signature P2. Transaction body P1 is a data body included in said transaction data. Digital signature P2 is generated for the hash value of transaction body P1 by using a signature key of a creator of said transaction data; more specifically, digital signature P2 is generated by encrypting said hash value with a private key of the creator of said transaction data. Examples of the type of the digital signature include the elliptic curve digital signature algorithm (ECDSA), CRYSTALS-Dilithium, Falcon, and SPHINCS+.

Because of including digital signature P2, the transaction data is virtually impossible to tamper with. This is because tampering with the transaction data will result in unsuccessful verification using digital signature P2, which reveals that the transaction data has been tampered with. Thus, transaction body P1 is protected from tampering.

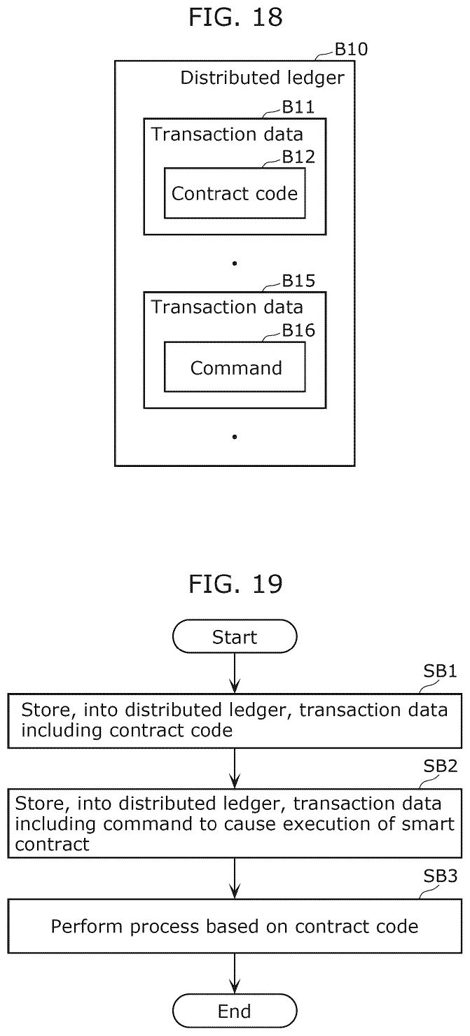

FIG. 18 is an explanatory diagram illustrating transaction data related to execution of a smart contract. FIG. 19 is an explanatory diagram illustrating processing related to execution of a smart contract.

With reference to FIG. 18 and FIG. 19, a series of processes related to the execution of the smart contract using the distributed ledger will be described.

In Step SB1, a node stores, into distributed ledger B10, transaction data B11 including contract code B12 in which the processing of the smart contract is written. For example, the node receives transaction data B11 from an information processing device via communication or the node itself generates transaction data B11 and thus, the node obtains transaction data B11, and stores obtained transaction data B11 into distributed ledger B10. Step SB1 is performed before the smart contract is executed.

In Step SB2, the node stores, into distributed ledger B10, transaction data B15 including command B16 to cause the execution of the smart contract. For example, the node receives transaction data B15 from an information processing device via communication and stores received transaction data B15 into distributed ledger B10.

In Step SB3, the node reads contract code B12 from distributed ledger B10 as a result of transaction data B15 including command B16 being stored into distributed ledger B10 in Step SB2, and performs a process based on contract code B12. The result of said process may be included in the transaction data and stored into distributed ledger B10.

When the distributed ledger system receives transaction data B15 including command B16 to cause the execution of the smart contract, the distributed ledger system automatically (in other words, without manual intervention) performs processes that follow command B16 by the above-described series of processes and can therefore perform the processes efficiently (in other words, at high speed or in a short time). Realization of the efficient processes results in the effect of reduced power consumption. Furthermore, since there is no manual intervention, tampering with information by a person, a fraudulent act, or a human error can be prevented. Moreover, since the result of the processes performed in this manner is stored into the blockchain, the result of the processes can be virtually impossible to tamper with.

Note that in the above-described embodiment or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the control device or the like according to each of the above-described embodiment and variations is a program described below.

Specifically, this program causes a computer to perform an information processing method that is to be performed by an information processing device using a processor and includes: obtaining content information related to digital content created by a user; recording, into a first distributed ledger system, a first non-fungible token (NFT) corresponding to the content information; generating a second NFT corresponding to the content information, the second NFT being for distribution; and recording the second NFT generated, into a second distributed ledger system different from the first distributed ledger system.

The control device or the like according to one or more aspects has been described thus far based on the embodiment, but the present disclosure is not limited to this embodiment. Various modifications to the present embodiment and forms configured by combining structural elements in different embodiments that can be conceived by those skilled in the art may be included within the scope of one or more aspects as long as these do not depart from the essence of the present disclosure.

### INDUSTRIAL APPLICABILITY

The present disclosure is useful as a control method, etc., in which digital content can be collected from users and digital content suitable for distribution can be effectively managed.

1. A control method to be performed by a control device, the control method comprising:
obtaining content information related to digital content created by a user;
recording, into a first distributed ledger system, a first non-fungible token (NFT) corresponding to the content information;
generating a second NFT corresponding to the content information, the second NFT being for distribution; and
recording the second NFT generated, into a second distributed ledger system different from the first distributed ledger system.

2. The control method according to claim 1, wherein
the first NFT includes information for specifying:
a user identification (ID) for identifying the user; and
a content ID for identifying the digital content, and the second NFT includes information for specifying the content ID.

3. The control method according to claim 2, wherein
the first distributed ledger system includes:
a user terminal owned by the user; and
the control device, and
the second distributed ledger system includes:
a distributor terminal owned by a distributor who distributes digital content; and
the control device.

4. The control method according to claim 2, wherein
in the obtaining, first transaction data including the content information is obtained to obtain the content information,
the control method further comprises:
recording the first transaction data into the first distributed ledger system, and
the first NFT is recorded by execution of a first contract code stored in the first distributed ledger system that is triggered by the recording of the first transaction data into the first distributed ledger system.

5. The control method according to claim 4, further comprising:
when the first NFT is recorded into the first distributed ledger system,
generating second transaction data including first NFT information related to the first NFT; and
recording the second transaction data into the second distributed ledger system, wherein
the second NFT is generated and recorded by execution of a second contract code stored in the second distributed ledger system that is triggered by the recording of the second transaction data into the second distributed ledger system.

6. The control method according to claim 2, further comprising:
obtaining third transaction data including the content ID and a first token for paying, to an administrator, remuneration for use of the digital content in distribution by a distributor;
recording the third transaction data into the second distributed ledger system; and
transferring the first token from an account of the distributor to an account of the administrator.

7. The control method according to claim 6, wherein
the first token is transferred by execution of a third contract code stored in the second distributed ledger system that is triggered by the recording of the third transaction data into the second distributed ledger system.

8. The control method according to claim 7, further comprising:
after the transferring of the first token, generating fourth transaction data including a second token and second NFT information corresponding to the content ID, the second token being for paying, to the user, remuneration for the use of the digital content in distribution and being at least part of the first token;
recording the fourth transaction data into the first distributed ledger system; and
transferring the second token from the account of the administrator to an account of an owner of the first NFT.

9. The control method according to claim 8, wherein
the second token is transferred by execution of a fourth contract code stored in the first distributed ledger system that is triggered by the recording of the fourth transaction data into the first distributed ledger system, and
in the transferring of the second token,
the first NFT recorded in the first distributed ledger system is specified based on the second NFT information included in the fourth transaction data, and
the second token is transferred to the account of the owner of the first NFT specified based on the first NFT.

10. A control device comprising:
a processor; and
memory, wherein
using the memory, the processor:
obtains content information related to digital content created by a user;
records, into a first distributed ledger system, a first non-fungible token (NFT) corresponding to the content information;
generates a second NFT corresponding to the content information, the second NFT being for distribution; and
records the second NFT generated, into a second distributed ledger system different from the first distributed ledger system.

11. A non-transitory computer-readable recording medium having stored therein a program for causing a computer to perform the control method according to claim 1.
